(19) United States
(12) Patent Application Publication
(10) Pub. No.: US 2016/0321720 A1
(43) Pub. Date: Nov. 3, 2016

(54) METHOD, SYSTEM AND COMPUTER PROGRAM PRODUCT FOR RELAYING CONSUMER-SUPPLIED MEDIA TO MERCHANTS

(71) Applicant: Tyrone J. King, Palatine, IL (US)

(72) Inventor: Tyrone J. King, Palatine, IL (US)

(21) Appl. No.: 14/698,719

(22) Filed: Apr. 28, 2015

(51) Int. Cl. G06Q 30/06; G06Q 50/18; G06F 9/445

(52) U.S. Cl. CPC G06Q 30/0611; G06F 8/60; G06Q 30/0609; G06Q 50/188

(57) ABSTRACT

A method, system and computer program product for relaying consumer-supplied media to a merchant is disclosed. In various embodiments, the consumer uploads a bid request comprising images, video, text, and/or audio to a server for subsequent relaying to a plurality of merchants. The consumer outlines parameters for work which needs to be done at real property in the bid request. Bids from merchants satisfying a credibility rating in some embodiments are relayed to the consumer for acceptance and/or denial.

### BACKGROUND

1. Field of the Invention

This invention relates to the display and transfer of media between a merchant and consumer for contracting purposes, and more particularly relates for display and transfer of video between a merchant and consumer for soliciting bids on materials and labor in construction.

2. Description of the Related Art

The functionality and features available on smart phones and mobile devices are rapidly evolving. For example, cellular phones, smart phones and tablet computers have become commonly integrated, multi-functional devices. They have evolved to have web-enabled functionality and various other communication capabilities (e.g., e-mail, text, wi-fi, etc.) including camera functions, sound signal capturing and processing, image scanning and graphical image handling functionalities and other capabilities—including the ability to record and process sound-based data and/or image-based data.

With the ever-increasing use of smart phones and tablet computers, consumers and merchants desire greater-and-greater remote interaction between one another than they traditionally had with conventional phone use. Media storage and transfer on smart phones is evolving and becoming ever larger.

Smart phones also have the capability of transferring a GPS location to a server of the phone using a GPS or other location service unit within the smart phone. The server processes the location information and can determine whether another device, consumer or merchant is at approximately the same location transmitted location information at approximately the same time, or within a certain geographic area. This may be accomplished by comparing time stamps from devices within a certain area. If the server detects more than two devices within an acceptable time period and within an acceptable distance from each other, the consumer may be sent a message asking the consumer confirmation it desires a transfer of data. As a result, consumers having mobile devices can exchange contact information without having to manually enter location information into the device.

However, providing a consumer needing a contractor at their home with some control in how their personal information and the personal requirements they have for the job to a merchant has so far been elusive.

For years, merchants, advertisers, telecommunications companies and banking and payment processing industries have been trying to engineer mobile transaction processing technologies that are secure, efficient and easy to use for facilitating the contracting between a consumer and a merchant for services, and facilitating payment for those services; however none that are efficient currently exist.

In view of the foregoing, it is clear that traditional systems, apparati and computer program products are not perfect and leave room for more optimal approaches to transferring media between consumers and merchants, facilitating the realization of a contract between those parties as well as payment.

### SUMMARY

From the foregoing discussion, it should be apparent that a need exists for a system and method for efficiently transferring media between consumers and merchants. Beneficially, such a system and method would provide for the relay of media showing a potential construction job, functionality for a contractor or merchant to submit a bid, and functionality for realizing a contract between the merchant and consumer.

The present invention has been developed in response to the present state of the art, and in particular, in response to the problems and needs in the art that have not yet been fully solved by currently available products. Accordingly, the present invention has been developed to provide a method for obtaining and transferring data to be used for preparation for an estimate for work, said method comprising the step of executing a mobile application on a processor of a mobile device, said device comprising a camera and wireless connectivity to the internet, wherein said mobile application performs the steps of: utilizing the camera to record video taken of an area for which the estimate is required; receiving a bid request from a consumer, the bid request comprising a name, email address, phone number and multimedia file having video and audio; relaying the bid request to a server; storing the bid request in computer-readable memory; transmitting the multimedia file to a plurality of merchants; receiving a bid from one or more of the merchants, the bid comprising a dollar figure; and forwarding the plurality of bids to the consumer.

In some embodiments, the method further comprises receiving confirmation from the consumer that a bid is accepting and forming a legally-binding contract between the merchant and consumer.

The method may further comprise prompting the consumer to make a payment for the work before the work is furnished.

The work to be quoted may be selected from the group consisting of moving of personal effect, remodeling, construction and area painting.

In alternative embodiments, the method further comprises determining a credibility rating for a merchant from ratings assigned to a merchant by other consumers previously having accepted bids from the merchant.

The method may further comprising eliminating bids from the plurality of bids originating with merchants whose credibility ratings fail to meet a predetermined threshold.

In various embodiments, the method further comprises the steps of filling out an online request form on the web site; receiving an activation code on the mobile device from the web site; and downloading the mobile application from the web site onto the mobile device.

A computer program product comprising a computer readable medium having computer usable program code executable to perform operations for obtaining and transferring data to be used for preparation for an estimate for work is also recited, the operations of the computer program product comprising: utilizing the camera to at least temporarily store photographs onto the mobile device, taken of an area for which the estimate is required; receiving a bid request from a consumer, the bid request comprising a name, email address, phone number and multimedia file having video and audio; relaying the bid request to a server; storing the bid request in computer-readable memory; transmitting the multimedia file to a plurality of merchants; receiving a bid from one or more of the merchants, the bid comprising a dollar figure; and forwarding the plurality of bids to the consumer.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an illustration of an image from a consumer produced media file illustrating an external perspective view of a fixture on a property in accordance with the present invention;

FIG. 2 is a block diagram depicting an exemplary layout on a browser on a mobile phone or personal computer in accordance with the present invention;

FIG. 3 is an illustration of an image from a consumer produced media file illustrating an internal perspective view of a property in accordance with the present invention;

FIG. 4 is an illustration of an image from a consumer produced media file illustrating an internal perspective view of a property in accordance with the present invention; and

FIG. 5 is a flow chart of the steps of a method of relaying consumer-produced media to a merchant in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

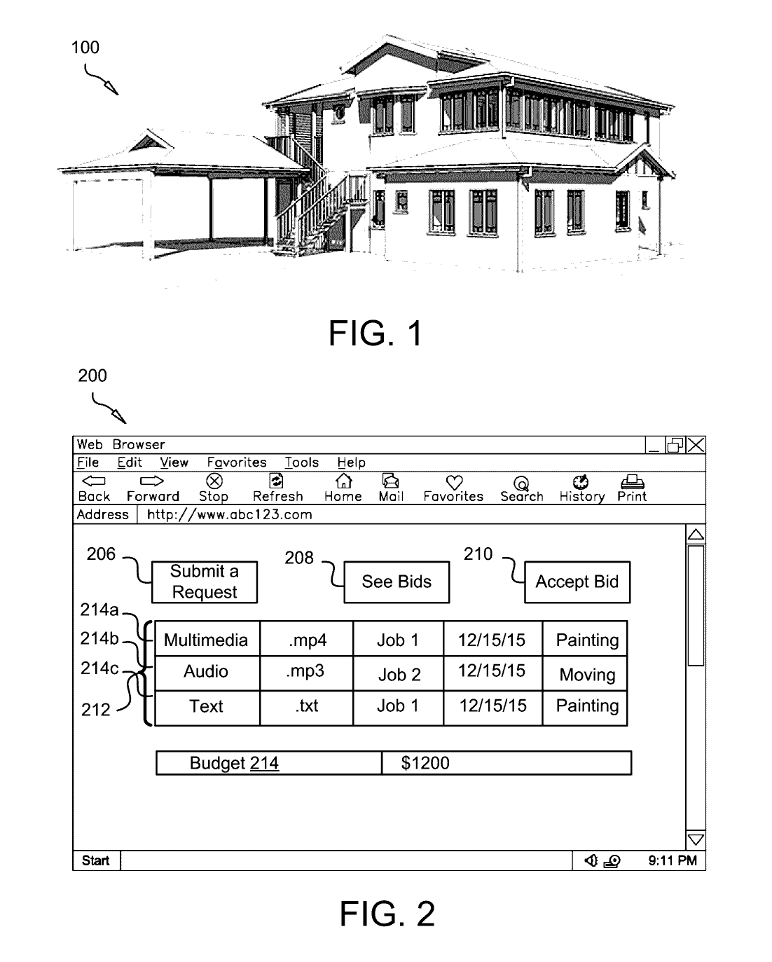

FIG. 1 is an illustration of an image from a consumer produced media file illustrating an external perspective view of a fixture 100 on a property in accordance with the present invention.

The illustration depicting an image of fixture on real property was taken from a multimedia file having both video and audio data produced by a consumer on a smart phone. In accordance with the present invention, a consumer desiring to procure bids on a construction job at a residential or commercial property may record video of the site to be constructed and record audio of the consumer explaining what construction needs to be done in the multimedia file. The multimedia file may be saved into computer-readable memory in the smart phone in any format commonly known to those of skill in the art, including MPEG.

MPEG codecs interleave packetized audio and video bitstreams, or elementary streams, into program streams created using standardized protocols to facilitate data transmission over one or more communication channel(s). Audio bitstreams are encoded to the MPEG standards in what has became known as the MPEG-1 Audio Layer 3 format, or MP3 format. MP3 codecs compress audio streams by reducing the accuracy of portions of the original audio stream considered to be beyond the auditory resolution ability of the average human ear.

In accordance with ISO Standard 11172, compressed MPEG media is comprised of layers of multiplexed information associated with, and forming, the compressed media (e.g. acoustic information is layered onto video information). In later versions of the MPEG standards, textual information, such as closed captions and even tactile information (e.g. Braille), are layered upon acoustic/audiographic and video information.

MPEG formatted media content from consumers containing information relevant for a merchant to bid the job are often stored in computer readable memory

The consumer and merchant may comprise any person, company or organization that needs or desires to view video content of any kind for any purpose.

The consumer and merchant may record and render the multimedia file using one or more computer programs running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

CPU 526 may be comprised of a single processor or multiple processors. CPU 526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory is used typically to transfer data and instructions to CPU in a bi-directional manner. Memory may include any suitable computer-readable media, intended for data storage, such as those described above excluding any wired or wireless transmissions unless specifically noted. Mass memory storage may also be coupled bi-directionally to CPU and provides additional data storage capacity and may include any of the computer-readable media described above. Mass memory storage may be used to store programs, data and the like and is typically a secondary storage medium such as a hard disk. It will be appreciated that the information retained within mass memory storage, may, in appropriate cases, be incorporated in standard fashion as part of memory as virtual memory.

The CPU may be coupled to GUI. The GUI enables a user to view the operation of computer operating system and software. The CPU may be coupled to the pointing device. Non-limiting examples of a pointing device include computer mouse, trackball and touchpad. Pointing devices enable a user with the capability to maneuver a computer cursor about the viewing area of GUI and select areas or features in the viewing area of GUI. CPU may be coupled to keyboard. The keyboard enables a user with the capability to input alphanumeric textual information to the CPU. The CPU may be coupled to microphone for recording audio from a consumer. The microphone enables audio produced by a consumer to be recorded, processed and communicated by the CPU. The CPU may also be connected to video camera which enables video produced or captured by consumer to be recorded, processed and communicated by the CPU.

The CPU may also be coupled to input/output interface that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

The multimedia file may be saved in a database server which may comprise any database management system (DBMS) or relational database management system (RDBMS) such as Oracle, DB2, IMS, MYSQL, which are highly tuned and carefully managed to ensure that database queries to the DBMS are serviced and returned as quickly as possible. The database server may comprise a processor and memory, which are well-known to those of skill in the art.

In the illustrated embodiment, the database server on the smart phone routes video content information, or content units, to a merchant via a wide-area network (WAN) such as the Internet. The content units, in various embodiments of the present invention, may comprise video signals, audio signals, textual information, and the like.

The data processor comprises the front end logic necessary to receive transmit bitstreams (i.e., datastreams). The data processor may include the software, firmware, and hardware necessary to receive and process video content, including buffers, data unloaders, video unloaders, and the like. The data processor is functionally capable of demultiplexing content units, such as MPEG compliant content units; analyzing the streams forming content units, such as elementary streams and program streams; remultiplexing content units; and extracting audio data from the content units.

In one implementation of the present invention, a method is disclosed, comprising: receiving a bid request from a consumer including a multimedia file associated with a proposed construction job; forwarding the multimedia file to a plurality of merchants who have previously requested to be included in communication; receiving a bid from a merchant (e.g. contractor) determining, in some embodiment, a credibility metric for the merchant/contractor; retrieving a confidence requirement based on the activity request; and determining whether the determined credibility metric satisfies a credibility requirement set by the consumer, and collecting payment from the consumer.

The credibility requirement may be an average of ratings previously associated with a particular merchant by consumers who have previously contracted with that merchant using the method or computer program product taught by this description.

In various embodiments, a consumer is prompted to complete an online request form. In some embodiments, the merchant may prompt the consumer to record video and/or audio of supplemental items in the interior or exterior of the property (such as the inside of cabinets or rooms).

The multimedia file uploaded by a consumer to a server may be up to 20 minutes in length in some embodiments, and a confirmation communication may be sent by the server to the consumer using methods known to those of skill in the art.

The exterior of a home 100 is depicted in FIG. 1. In the shown embodiment, a consumer is requesting painting work on the exterior of the home. In the shown embodiment, the video from which the image of the home 100 is drawn is relayed to a plurality of merchants along with audio recording of the consumer explaining details of the painting job, along with measurement of the home 100.

FIG. 2 is a block diagram depicting an exemplary layout 200 on a browser on a mobile phone or personal computer in accordance with the present invention.

The layout 200 comprises a plurality of virtual controls allowing a consumer to submit a bid request to a merchant and accept a bid from a merchant. These bid controls comprise virtual buttons 206-210 which allow a consumer to submit a bid request, see bids that have been submitted by merchants, and accept a bid from the bids submitted by merchants.

The layout 200 comprises a list 212 of files 214a-c submitted with one more bid requests (i.e. jobs). In the shown embodiment, file 214a comprises a multimedia file in .MP4 format submitted in connection with a painting job 1 which must be completed by Dec. 15, 2015.

A budget 214 is also shown in the layout 200, which comprises a numerical dollar amount representing the maximum budget that the consumer has for a particular job. The budget 214 may be optionally included by the consumer in some embodiments.

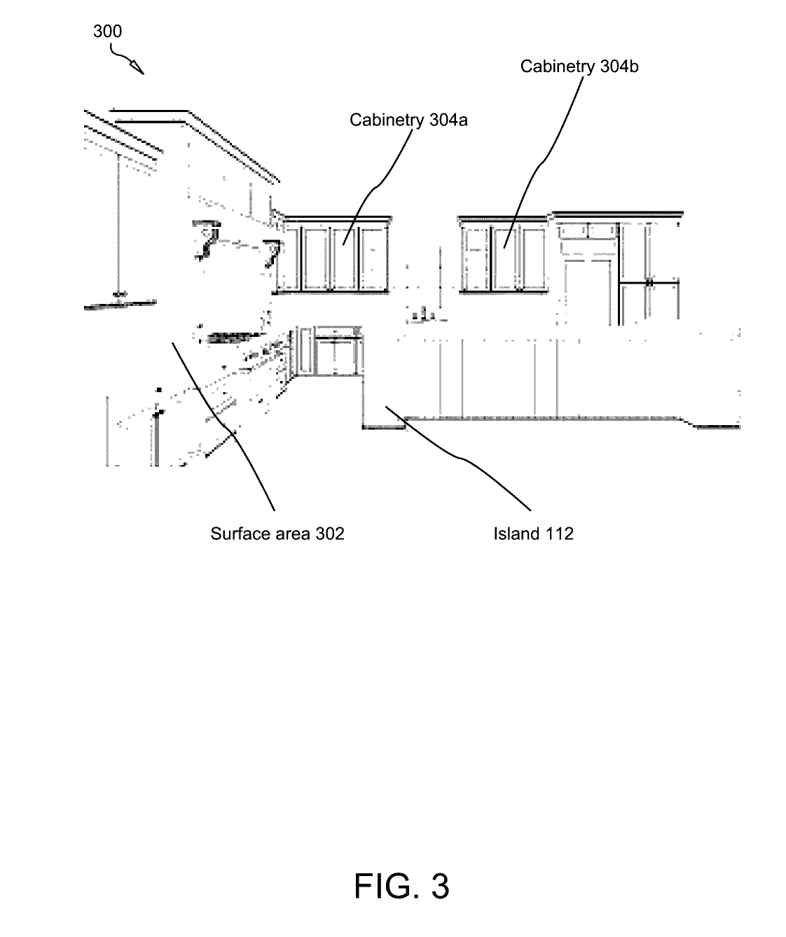

FIG. 3 is an illustration of an image 300 from a consumer produced media file illustrating an internal perspective view of a property in accordance with the present invention.

The image 300 may be drawn from a video file, photograph, computer-generated model, and/or blue prints.

The property depicted by the image 300 in a kitchen. The kitchen comprises surface area 302, an island 112, cabinetry 304a, and cabinetry 304b.

The consumer may draw circles around the portions of the kitchen in the image 300 before relaying it to merchants and a server. These circles may be labeled as areas needing attention by a merchant/contractor in text relayed with the image 300.

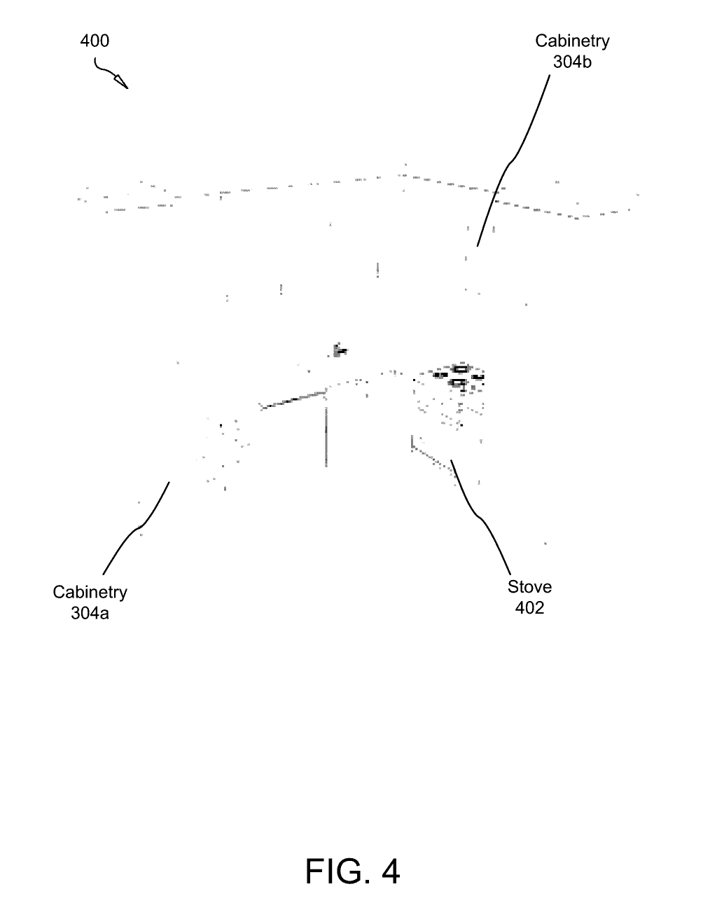

FIG. 4 is an illustration of an image 400 from a consumer produced media file illustrating an internal perspective view of a property in accordance with the present invention.

The property comprises cabinetry 304b, cabinetry 304a, and a stove 402. This image 400 may be relayed to merchant for bidding on a furnishing the kitchen with an appliance, adding cabinets, or moving items out of the kitchen.

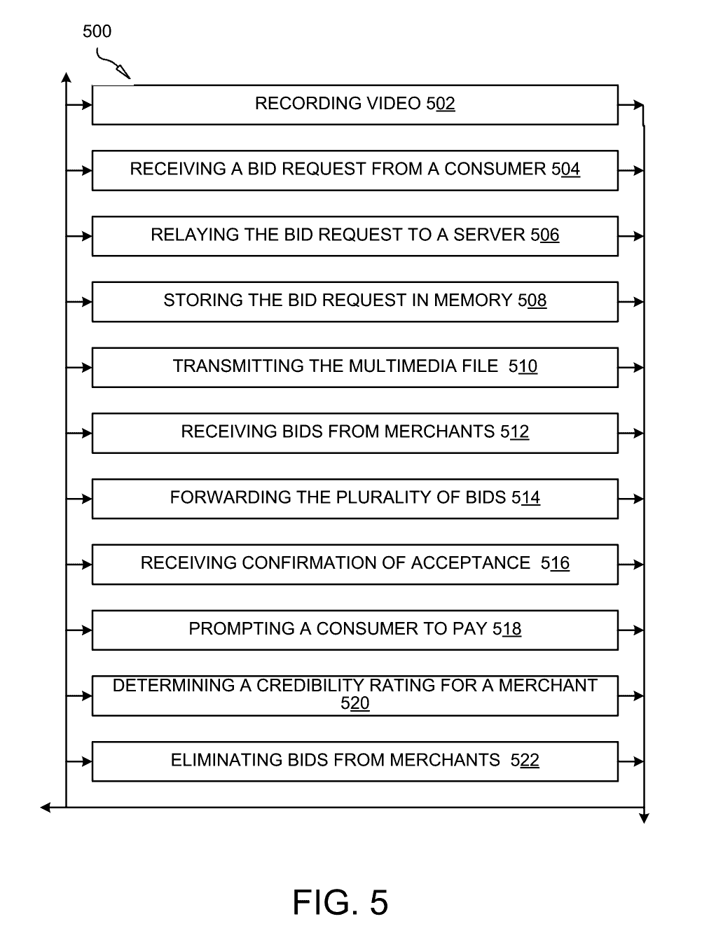

FIG. 5 is a flow chart of the steps of a method of relaying consumer-produced media to a merchant in accordance with the present invention.

The method comprises the step of executing a mobile application on a processor of a mobile device, said device comprising a camera and wireless connectivity to the internet, wherein said mobile application performs the steps of: utilizing the camera to at least temporarily store photographs onto the mobile device, taken of an area for which the estimate is required; establishing a connection with a web site belonging to a contractor from whom the estimate is required; and transmitting the photographs to the web site.

In a further embodiment method the work to be quoted is selected from the group consisting of moving of items, remodeling, and area painting. In a still further embodiment method the method further includes the steps of: filling out an online request form on the web site; receiving an activation code on the mobile device from the web site; and downloading the mobile application from the web site onto the mobile device.

In one embodiment, the WAN or global network may operate as the Internet. Non-limiting examples of forms a global network include local area networks (LANs), wide area networks (WANs), wired telephone networks, wireless networks, or any other network supporting data communication between respective entities.

In various embodiments, the credibility rating for a merchant is a function of previous ratings assigned to that merchant by consumers. For instance, consumers may be prompted to rate a merchant from one to five, and those ratings collectively averaged to determine a credibility rating for a merchant.

In various embodiments, the consumer may determine a threshold, or predetermined threshold, for accepting bids from merchants. If merchants bidding on a job (or bid request) have credibility rating which fall below the threshold set by the consumer.

The consumer's smart phone may be coupled to network interface which enables communication with an external device such as a database or a computer or telecommunications or internet network using an external connection shown generally as communication channel, which may be implemented as a hardwired or wireless communications link using suitable conventional technologies. With such a connection, the smart phone might receive information from the network, or might output information to a network in the course of performing the method steps described in the teachings of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for obtaining and transferring data to be used for preparation for an estimate for work, said method comprising the step of executing a mobile application on a processor of a mobile device, said device comprising a camera and wireless connectivity to the internet, wherein said mobile application performs the steps of:
utilizing the camera to record video taken of an area for which the estimate is required;
receiving a bid request from a consumer, the bid request comprising a name, email address, phone number and multimedia file having video and audio;
relaying the bid request to a server;
storing the bid request in computer-readable memory;
transmitting the multimedia file to a plurality of merchants;
receiving a bid from one or more of the merchants, the bid comprising a dollar figure; and
forwarding the plurality of bids to the consumer.

2. The method of claim 1, further comprising receiving confirmation from the consumer that a bid is accepting and forming a legally-binding contract between the merchant and consumer.

3. The method of claim 1, further comprising prompting the consumer to make a payment for the work before the work is furnished.

4. The method of claim 1 wherein the work to be quoted is selected from the group consisting of moving of personal effect, remodeling, construction and area painting.

5. The method of claim 1, further comprising determining a credibility rating for a merchant from ratings assigned to a merchant by other consumers previously having accepted bids from the merchant.

6. The method of claim 1, further comprising eliminating bids from the plurality of bids originating with merchants whose credibility ratings fail to meet a predetermined threshold.

7. The method of claim 1 wherein the method further includes the steps of
filling out an online request form on the web site;
receiving an activation code on the mobile device from the web site; and
downloading the mobile application from the web site onto the mobile device.

8. A computer program product comprising a computer readable medium having computer usable program code executable to perform operations for obtaining and transferring data to be used for preparation for an estimate for work, the operations of the computer program product comprising:
utilizing the camera to at least temporarily store photographs onto the mobile device, taken of an area for which the estimate is required;
receiving a bid request from a consumer, the bid request comprising a name, email address, phone number and multimedia file having video and audio;
relaying the bid request to a server;
storing the bid request in computer-readable memory;
transmitting the multimedia file to a plurality of merchants;
receiving a bid from one or more of the merchants, the bid comprising a dollar figure; and
forwarding the plurality of bids to the consumer.

9. The computer program product of claim 8, further comprising receiving confirmation from the consumer that a bid is accepting and forming a legally-binding contract between the merchant and consumer.

10. The computer program product of claim 8, further comprising prompting the consumer to make a payment for the work before the work is furnished.

11. The computer program product of claim 8, wherein the work to be quoted is selected from the group consisting of moving of personal effect, remodeling, construction and area painting.

12. The computer program product of claim 8, further comprising determining a credibility rating for a merchant from ratings assigned to a merchant by other consumers previously having accepted bids from the merchant.

13. The computer program product of claim 8, further comprising eliminating bids from the plurality of bids originating with merchants whose credibility ratings fail to meet a predetermined threshold.

14. The computer program product of claim 8, wherein the method further includes the steps of
filling out an online request form on the web site;
receiving an activation code on the mobile device from the web site; and
downloading the mobile application from the web site onto the mobile device.
